(19) United States
(12) Patent Application Publication
(10) Pub. No.: US 2008/0116684 A1
(43) Pub. Date: May 22, 2008

(54) MINI PATCH LAMINATE

(75) Inventor: Donald GALLES, Blaine, MN (US)

Correspondence Address: HAMRE, SCHUMANN, MUELLER & LARSON, P.C., P.O. BOX 2902, MINNEAPOLIS, MN, 55402-0902, US

(73) Assignee: DataCard Corporation, Minnetonka, MN (US)

(21) Appl. No.: 11/941,505

(22) Filed: Nov. 16, 2007

Related U.S. Application Data
(60) Provisional application No. 60/866,097, filed on Nov. 16, 2006.

(51) Int. Cl. B42D 15/10; B44F 1/00

(52) U.S. Cl. 283/75

(57) ABSTRACT

A mini patch that is laminated over a portion of an identification document surface that is significantly less than the entire surface area. The mini patch can cover a specific area of personalized information on the document surface to protect the personalized information from wear and tampering. For example, the mini patch can cover a photograph, leaving the remainder of the surface uncovered.

### PRIORITY DATA

This application claims the benefit of U.S. Provisional Patent Application Ser. No. 60/866,097 entitled “MINI PATCH LAMINATE,” filed on Nov. 16, 2006, which is incorporated by reference in its entirety.

### FIELD

This disclosure relates to a protective laminate for use on an identification document, such as plastic or composite cards including identification cards, credit and debit cards, and the like, as well as passports. More particularly, this disclosure relates to a mini patch that can be laminated over a portion of an identification document surface that is significantly less than the entire surface area.

### BACKGROUND

Identification documents such as identification cards, credit and debit cards, and the like, and passports, are personalized with information concerning the intended holder of the identification document and then issued to the intended holder.

The surfaces of identification documents are often laminated with a clear film patch to protect the surface, and the underlying personalization, from wear and tampering. As shown in FIG. 1, the film patch 2 typically covers almost the entire surface area of the document 4 minus a small border 6, for example a 0.060 inch wide border.

It is also known to apply thin hot stamp patches on select areas of identification document surfaces. The hot stamp patches are typically an Optically Variable Device (OVD), also commonly called a hologram, or other security device. Due to the material of the hot stamp patches, and in light of how thin the hot stamp patches are, the hot stamp patches are not generally considered sufficient to protect underlying personalization information from wear and tampering, and an overlying protective laminate is typically applied over generally the entire card surface (less the small border) including the hot stamp patch.

There may be situations where a smaller protective film patch that covers only a portion of the document surface may be desirable.

### SUMMARY

A protective mini patch is described that can be laminated over a portion of an identification document surface that is significantly less than the entire surface area. The mini patch can cover a specific area of personalized information on the document surface to protect the personalized information from wear and tampering. For example, the mini patch can cover a color photograph, leaving the remainder of the surface uncovered.

The mini patch can be used in conjunction with a card that has personalization applied using laser engraving. When personalized information is laser engraved onto a card, the laser softens the plastic material of the card. Since the mini patch only covers a small portion of the card, the laser engraving does not interfere with subsequent application of the mini patch. On the other hand, if a conventional card-sized laminate is immediately laminated over the laser engraving, the laminate may not adhere well to the softened plastic material of the laser engraved area. If the laser engraving is performed after the conventional card-sized laminate is applied, the laser tends to create bubbling in the laminate.

### DRAWINGS

FIG. 1 illustrates a conventional card and film patch.

FIG. 2 illustrates a card with a mini patch.

FIG. 3 illustrates a web containing a plurality of mini patches prior to lamination.

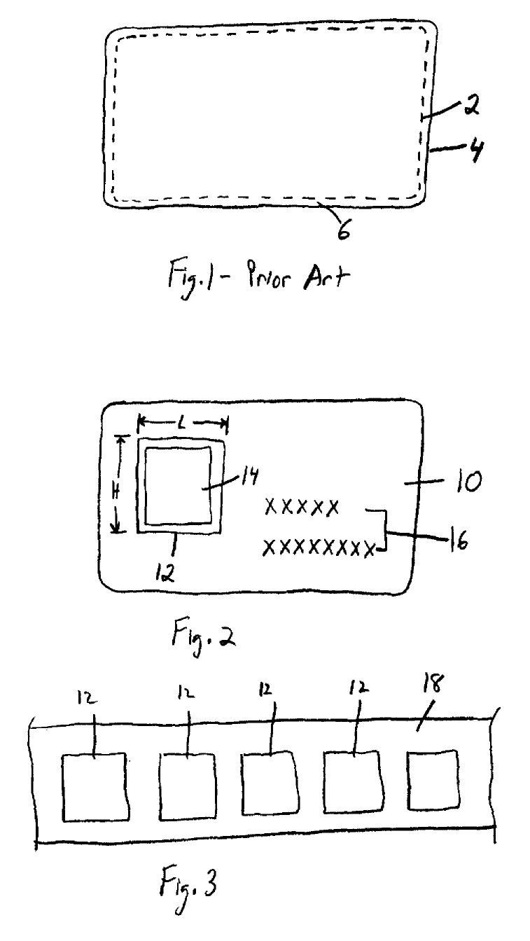

### DETAILED DESCRIPTION

FIG. 2 illustrates an identification document 10 with a mini patch 12. The identification documents 10 can be any identification document that has personalization or other information that is to be protected by a laminate. Examples of identification documents include plastic and composite cards, for example identification cards, credit and debit cards, and the like, and passports. To facilitate the description, the identification document 10 will hereinafter be described as being an identification card or just a card. The card can be any size of card, for example an ID-1 card, or any shape of card, on which a laminate is used to protect the card surface.

The card 10 includes a photograph 14, for example a color photograph, of the intended card holder applied thereto. The photograph 14 can be printed onto the card surface using known printing techniques, for example dye sublimation, or by an image transfer technique in which the photo is first printed onto a transfer layer which is then laminated to the card surface.

The card 10 can also include additional personalization 16, for example a unique identifier such as an account or serial number, and the card holder's name. The additional personalization 16 can be applied using known techniques, for example laser engraving.

As illustrated in FIG. 2, the mini patch 12 is laminated over the photograph 14. The mini patch 12 is sized to cover the photograph 14 leaving a significant portion of the card surface uncovered. For example, in the case of a photograph on a driver's license, the mini patch 12 can have a height 11 of about 1.42 inches (36.068 mm) and a length L of about 1.09 inches (27.686 mm). Further information on a mechanism for laminating a mini patch to a card can be found in U.S. patent application Ser. No. 11/557,615, filed on Nov. 8, 2006.

Although the mini patch 12 is described and illustrated as covering the photograph 14, the patch 12 could be sized and shaped to cover other specific personalization information on the card other than the photograph. For example, the patch 12 could cover some or all of the personalization information 16 while not covering the photograph 14.

FIG. 3 illustrates a number of mini patches 12 disposed on a carrier web 18. The patches 12 are made of a material, for example polyester, that renders the laminates generally clear or translucent to permit substantially unobstructed, unaltered viewing of the photograph 14 or other information over which it is laminated. The web 18 and patches 12 are typically provided in roll form. Although the patches 12 have been described as being clear, the patches 12 can be provided with overt or covert optically variable devices (OVD's), graphics, micro-printing, UV printing, etc. The patches preferably have a thickness between about 0.0004-0.0015 inches (about 0.5 mil-1.5 mil) which is generally much thicker than conventional hot stamp patches.

The patch 12 covers only a portion of the card surface, leaving a significant portion of the card surface uncovered. In this way, the additional personalization 16 that is applied to the card surface, for example using laser engraving, does not interfere with the function and performance of the patch 12. The additional personalization would typically be applied prior to securing the patch 12 over the photograph 14. However, the additional personalization could be performed after securing the patch to the card.

The concepts described herein can be used on central issuance personalization equipment, for example the Maxsys system available from DataCard Corporation of Minnetonka, Minn., or on desktop machines, for example the SP75 line of printers available from DataCard Corporation of Minnetonka, Minn.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A mini patch laminate for lamination to an identification document having a surface with a surface area and where the surface includes personalization information, comprising:
a layer of clear, polyester material configured for lamination over a portion of the surface of the identification document that is significantly less than the entire surface area to allow substantially unobstructed, unaltered viewing of personalization information; the layer having a thickness between about 0.5 mil-1.5 mil.

2. The mini patch laminate of claim 1, wherein the layer is generally rectangular in shape, and has a height of about 36 mm and a length of about 28 mm.

3. The mini patch laminate of claim 1, wherein the layer includes an optical variable device, graphics, or printing thereon.

4. The mini patch laminate of claim 1, wherein the layer is configured for lamination to an ID-1 card.

5. A mini patch laminate supply, comprising:
a carrier web;
a plurality of mini patch laminates disposed on the carrier web and spaced from one another for lamination to identification documents each of which has a surface with a surface area and where the surface includes personalization information; each mini patch laminate includes a layer of clear, polyester material configured for lamination over a portion of the surface of the identification document that is significantly less than the entire surface area to allow substantially unobstructed, unaltered viewing of personalization information; each mini patch laminate having a thickness between about 0.5 mil-1.5 mil.

6. The mini patch laminate supply of claim 5, wherein each mini patch laminate is generally rectangular in shape, and has a height of about 36 mm and a length of about 28 mm.

7. The mini patch laminate supply of claim 5, wherein a plurality of said mini patch laminates include an optical variable device, graphics, or printing thereon.

8. The mini patch laminate supply of claim 5, wherein each mini patch laminate is configured for lamination to an ID-1 card.

9. An identification document, comprising:
a surface with a surface area and the surface includes a photograph of the intended holder of the identification document;
a mini patch laminate laminated to the surface over the photograph, the mini patch laminate is sized to cover the entire photograph while leaving a significant portion of the surface area uncovered; the mini patch laminate having a thickness between about 0.5 mil-1.5 mil.

10. The identification document of claim 9, wherein the document is an ID-1 card.

11. The identification document of claim 9, wherein the mini patch laminate is generally rectangular in shape, and has a height of about 36 mm and a length of about 28 mm.

12. The identification document of claim 9, wherein the mini patch laminate includes an optical variable device, graphics, or printing thereon.

13. The identification document of claim 9, wherein the mini patch laminate comprises polyester material.
